(19) United States
(12) Patent Application Publication
(10) Pub. No.: US 2026/0234047 A1
(43) Pub. Date: Aug. 13, 2026

(54) SUPPORT FOR A CONTINUOUS STRIP PRODUCED DURING HEAT CHAMFERING OF GLASS SUBSTRATE, RELATED METHODS, AND GLASS SUBSTRATE PRODUCED THEREFROM

(71) Applicant: CORNING INCORPORATED, CORNING, NY (US)

(72) Inventors: JooYoung Lee, Asan-si (KR); Choon-bong Yang, Asan-si (KR)

(21) Appl. No.: 19/472,855

(22) PCT Filed: Apr. 3, 2024
(86) PCT No.: PCT/US2024/022733

§ 371 Date: Oct. 6, 2025

Related U.S. Application Data
(60) Provisional application No. 63/458,982, filed on Apr. 13, 2023.

(51) Int. Cl. C03B 33/03; B28D 1/22; B28D 1/30; B28D 7/04; C03B 33/037; C03B 33/09

(52) U.S. Cl. CPC C03B 33/03; B28D 1/221; B28D 1/30; B28D 7/04; C03B 33/037; C03B 33/09

(57) ABSTRACT

A support for a continuous strip formed during chamfering of a glass substrate that is situated on a jig includes one or more platform structures positioned adjacent to the jig and configured to reduce vibration of the continuous strip as the continuous strip grows during the chamfering of the glass substrate. The one or more platform structures are further configured to maintain an angle that the continuous strip forms with the glass substrate during chamfering.

### CROSS-REFERENCE TO RELATED APPLICATIONS

This application claims the benefit of priority under 35 U.S.C. § 119 of U.S. Provisional Application No. 63/458,982 filed Apr. 13, 2023, the content of which is incorporated herein by reference in its entirety.

### BACKGROUND OF THE DISCLOSURE

The present disclosure generally relates to an apparatus for heat chamfering a glass substrate and, in particular, to a support for a continuous strip produced during heat chamfering the reduces defects in the chamfered edge.

Edge defects in a glass substrate are a common source of damage to the glass substrate and thus reduce the reliability of the glass substrate. In particular, a flexible device including a thin glass substrate benefits from superior edge quality for reliable bending performance. In such a flexible device, the removal of edge defects is desirable. Edge finishing may be performed in order to improve the edge strength of a glass substrate. From among such edge finishing technologies, heat chamfering is a relatively new technique that advantageously does not create particles and is suitable for use with thin glass substrates. Notwithstanding, heat chamfering creates a continuous strip of glass that is peeled from the glass substrate, and this continuous strip is subject to vibrations, which can lead to diminished edge quality.

### SUMMARY OF THE DISCLOSURE

In one aspect, embodiments of the present disclosure relate to a support for a continuous strip formed during chamfering of a glass substrate that is situated on a jig. The support includes one or more platform structures positioned adjacent to the jig and configured to reduce vibration of the continuous strip as the continuous strip grows during the chamfering of the glass substrate.

In another aspect, embodiments of the present disclosure relate to a method of chamfering an edge of a glass substrate. In the method, a tool is moved around the edge of the glass substrate to remove glass material in a continuous strip. Further, the continuous strip is supported on a platform structure to reduce vibration of the continuous strip during removal of the glass material from the glass substrate.

In still another aspect, embodiments of the present disclosure relate to a glass substrate. The glass substrate includes a glass body having a first major surface, a second major surface opposite to the first major surface, and a heat chamfered edge extending at least partially around the glass body between the first major surface and the second major surface. On the glass substrate, a maximum peak-to-trough surface roughness R_{z} of the heat chamfered edge is 10.0 μm or less.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiments, and together with the description serve to explain principles and operation of the various embodiments. In the drawings:

FIG. 1 depicts top view a glass substrate with a heat-chamfering tool moving around the perimeter of the glass substrate, according to an exemplary embodiment;

FIG. 2 depicts a side view of the glass substrate and heat-chamfering tool shown in FIG. 1, according to an exemplary embodiment;

FIG. 3 depicts an exploded side view of an apparatus for supporting the glass substrate during beat-chamfering, according to an exemplary embodiment;

FIG. 4 depicts top view of the apparatus shown in FIG. 3, according to an exemplary embodiment;

FIG. 5 depicts stages of continuous strip development during heat-chamfering, according to an exemplary embodiment;

FIG. 6 depicts a top view of a support for the continuous strip developed during heat-chamfering, according to a first exemplary embodiment;

FIG. 7 depicts a side view of the support shown in FIG. 6, according to an exemplary embodiment;

FIG. 8 depicts a top view of another support for the continuous strip developed during heat-chamfering, according to a second exemplary embodiment;

FIG. 9 depicts a side view of the support shown in FIG. 8, according to an exemplary embodiment;

FIG. 10 depicts an arch of the support shown in FIGS. 8 and 9, according to an exemplary embodiment;

FIG. 11 depicts a top view of still another support for the continuous strip developed during heat-chamfering, according to a third exemplary embodiment;

FIG. 12 depicts arches of the support shown in FIG. 11 moving independently, according to an exemplary embodiment;

FIG. 13 depicts an arch with proximity or distance sensors, according to an exemplary embodiment;

FIG. 14 depicts a photomicrograph of a chamfered edge of a glass substrate produced using a support for a continuous strip according to the present disclosure;

FIG. 15 is a photomicrograph of Hackle marks on a chamfered edge of a glass substrate, which may be produced when the glass strip is not supported during chamfering; and

FIG. 16 is a photomicrograph of unevenness on a chamfered edge of a glass substrate, which may be produced when the glass strip is not supported during chamfering.

### DETAILED DESCRIPTION

Embodiments of the present disclosure relate to a support for a continuous glass strip produced during a heat chamfering process of a glass substrate as well as to a glass substrate produced using same. As will be described more fully below, the support improves the quality and reduces the defects in the chamfered edge by reducing vibrations and providing consistent tension between the continuous strip and glass substrate. In embodiments, the support includes one or more rails that spiral around a jig configured to hold the glass substrate during heat chamfering. The rails decrease in height as they spiral around the jig to maintain the angle and tension of the continuous strip with the glass substrate. In other embodiments, the support includes one or more arches on a movable base that travel around the jig during heat chamfering. In still other embodiments, each arch is provided on its own movable base that moves independently of the other movable bases. In this way, the continuous strip is supported as it grows during heat chamfering substantially no matter how the continuous strip develops. These and other aspects and advantages of the support for a continuous glass strip, method of heat chamfering glass using same, and glass substrate produced thereby will be described in greater detail below and in relation to the accompanying figures. These exemplary embodiments are provided by way of illustration, and not by way of limitation.

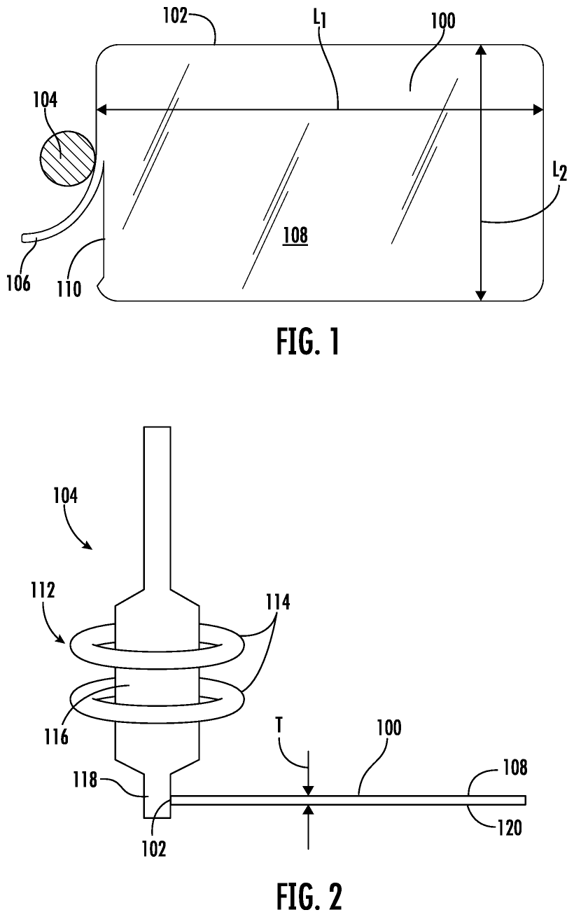

FIG. 1 schematically depicts a glass substrate 100 undergoing a heat-chamfering process according to an embodiment of the present disclosure. Heat-chamfering involves applying a thermal shock to an edge 102 of the glass substrate 100. In one or more embodiments, the thermal shock is induced by contacting the edge 102 of a room temperature glass substrate 100 with a chamfering tool 104. The difference in temperature between the glass substrate 100 and the chamfering tool 104 causes the edge 102 of the glass substrate 100 to beat quickly as compared to the interior of the glass substrate 100, causing a strip 106 of glass to break and separate from the glass substrate 100. As the chamfering tool 104 moves around the edge 102 of the glass substrate 100, contacting and applying a substantially constant pressure to the edge 102 of the glass substrate 100, the strip 106 continues to separate from the glass substrate 100, growing in size to form a continuous strip 106. In one or more embodiments, the glass substrate 100 is moved relative to a stationary chamfering tool 104, and in one or more other embodiments, the chamfering tool 104 is moved relative to stationary glass substrate 100.

In one or more embodiments, heat chamfering can be applied to any of a variety of glass materials of the glass substrate 100. In one or more embodiments, the glass substrate 100 is a glass body formed from borosilicate glass, aluminosilicate glass, or boroaluminosilicate glass, among others. Commercially available glasses suitable for use according to embodiments of the present disclosure are sold under the names Eagle XG®, LOTUS™, Gorilla®, Iris®, Astra™, and Victus®, each available from Corning Incorporated, Corning, NY.

In one or more embodiments, the edge 102 of the substrate 100 defines a shape of the glass substrate 100. In one or more embodiments, the glass substrate 100 has a shape, such as oblong, polygon, circle, or ellipse, among others. In one or more embodiments, the glass substrate 100 has a thickness smaller than either the transverse length or the longitudinal length. In one or more other embodiments, the glass substrate 100 has a thickness greater than one or both of the transverse length or longitudinal length.

In the embodiment shown in FIG. 1, the glass substrate 100 has the shape of a rounded rectangle defined by a first major surface 108. The first major surface 108 has a first length L₁ and a second length L₂. The first length L₁ is the longest length across the glass substrate 102, and the second length L₂ is transverse to the first length L₁. In one or more embodiments, the glass substrate 100 has a first length L₁ of from 30 mm to 500 mm. In one or more embodiments, the glass substrate 100 has a second length L₂ of from 30 mm to 200 mm.

During chamfering, the strip 106 is peeled off from the glass substrate 100 without creating particles. Removing the thin strip 106 from the glass substrate 100 creates a chamfered edge 110 that is substantially free of defects and that is strengthened compared to the edge 102 prior to chamfering. In one or more embodiments, the strip 106 has a thickness in a range from 100 μm and 300 μm. The thickness of the strip 106 can be controlled based on the temperature of the chamfering tool 104 and the speed at which the chamfering tool 104 is moved along the edge 102. A higher temperature and/or a slower speed will produce a greater strip 106 thickness.

Additional details regarding the heat chamfering process can be found in PCT Application Nos. PCT/US2022/022792 (filed on Mar. 31, 2022), PCT/US2021/063942 (filed on Dec. 17, 2021), and PCT/US2022/023978 (filed Apr. 8, 2022), the entireties of which are incorporated herein by reference thereto.

In one or more embodiments, the chamfered edge 110 of the glass substrate 100 comprises an edge strength of 600 MPa or greater. In one or more embodiments, the edge strength of the heat-chamfered edge is in a range from about 600 MPa to about 1400 MPa, from about 650 MPa to about 1400 MPa, from about 700 MPa to about 1400 MPa, from about 750 MPa to about 1400 MPa, from about 800 MPa to about 1400 MPa, from about 850 MPa to about 1400 MPa, from about 900 MPa to about 1400 MPa, from about 1000 MPa to about 1400 MPa, from about 600 MPa to about 1350 MPa, from about 600 MPa to about 1300 MPa, from about 600 MPa to about 1250 MPa, from about 600 MPa to about 1200 MPa, from about 600 MPa to about 1150 MPa, from about 600 MPa to about 1100 MPa, from about 600 MPa to about 1050 MPa, from about 600 MPa to about 1000 MPa, from about 600 MPa to about 950 MPa, from about 600 MPa to about 900 MPa, from about 600 MPa to about 850 MPa, or from about 600 MPa to about 700 MPa). In one or more embodiments, the edge strength is measured by a two-point bend test.

In one or more embodiments, any flaws found on chamfered edge 110 have a maximum length of 11 μm or less (e.g., from about 0.1 μm to about 11 μm, from about 0.1 μm to about 10 μm, from about 0.1 μm to about 9 μm, from about 0.1 μm to about 8 μm, from about 0.1 μm to about 7 μm, from about 0.1 μm to about 6 μm, from about 0.1 μm to about 5 μm, from about 0.1 μm to about 4 μm, from about 0.1 μm to about 3 μm, from about 0.1 μm to about 2 μm, from about 0.1 μm to about 1 μm, from about 0.5 μm to about 11 μm, from about 1 μm to about 11 μm, from about 2 μm to about 11 μm, from about 3 μm to about 11 μm, from about 4 μm to about 11 μm, from about 5 μm to about 11 μm, from about 6 μm to about 11 μm, from about 7 μm to about 11 μm, from about 8 μm to about 11 μm, or from about 9 μm to about 11 μm).

FIG. 2 depicts a side view of the glass substrate 100 undergoing chamfering. As can be seen in FIG. 2, the chamfering tool 104 is a metal rod, such as a metal rod formed of MoSi₂. In one or more embodiments, the chamfering tool 104 is heated by a heating element 112, such as through induction heating; however, in one or more other embodiments, another heating elements 112 is used, such as a resistive heating element. Further, in one or more embodiments, the heating element 112 is incorporated into the structure of the chamfering tool 104.

In the embodiment depicted, the heating element 112 is one or more induction coils 114 that heat the chamfering tool 104 using high-frequency induction heating. The chamfering tool 104 extends through the center of the induction coils 114. In particular, in one or more embodiments, chamfering tool 104 includes a heated portion 116 and a contact portion 118. As shown in FIG. 2, the heated portion 116 is disposed within the induction coils 114, such that the heated portion 116 is heated by the induction coils 114 and heat flows to the contact portion 118, which contacts the glass substrate 100. In one or more embodiments, the cross-sectional area of the contact portion 118 is smaller than the cross-sectional area of the heated portion 116.

In one or more embodiments, the induction coils 114 of the heating element 112 are implemented using a copper (Cu) coils. In one or more embodiments, the outer surface of the induction coils 114 are coated with a ceramic material for electrical safety. In one or more embodiments, cooling water flows within the induction coils 114. In one or more embodiments, the induction coil heating element 112 heats the chamfering tool 104 to a temperature in a range from about 1200° C. to about 1300° C. by transmitting power to the chamfering tool 104.

FIG. 2 also depicts the first major surface 108 of the glass substrate 100, and the glass substrate 100 further includes a second major surface 120 opposite to the first major surface 108. The first major surface 108 and the second major surface 120 define the thickness T therebetween. In one or more embodiments, the thickness is from 10 μm to 1 mm, in particular from 50 μm to 250 μm. The first major surface 108, the second major surface 120, and the edge 102 and/or heat chamfered edge 110 form boundaries of a glass body that define the glass substrate 100.

FIG. 3 is a schematic illustration of a jig 122 for holding the glass substrate 100 during heat chamfering according to one or more embodiments of the present disclosure. In one or more embodiments, the jig 122 includes a contact support portion 124 supporting the glass substrate 100 while being in contact with the glass substrate 100 and a base portion 126 supporting the contact support portion 124 while being spaced apart from the glass substrate 100 without contact therewith. In one or more embodiments, the contact support portion 124 is located closer to the heating element 112 than the base portion 126.

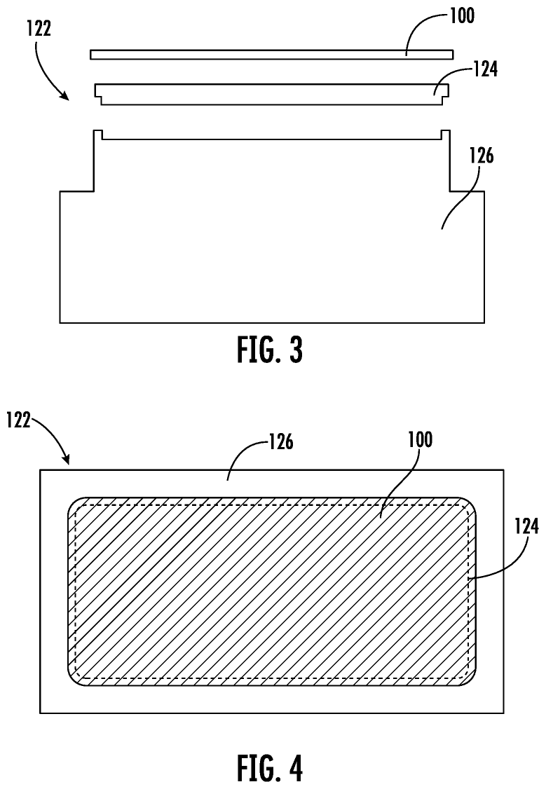

FIG. 4 is a schematic plan view of the jig 122 of in FIG. 3. The contact support portion 124 (shown in dashed lines) supports the glass substrate 100 by direct contact with the glass substrate 100 during the heat chamfering process. For this reason, in one or more embodiments, the contact support portion 124 is formed from a first material that has a low thermal conductivity, low coefficient of thermal expansion, and low coefficient of friction with the glass substrate 100. In one or more embodiments, the first material is a carbon material, such as isotropic graphite (e.g., available from Ibiden Co., Ltd.). Advantageously, such a material has low thermal conductivity to prevent a temperature increase in the glass substrate 100, thereby protecting the glass substrate 100 against heat damage. Such a material also has a low coefficient of thermal expansion to prevent a size change during heat chamfering. In addition, the carbon material is relatively soft to prevent scratches on the surface of the glass substrate 100.

The base portion 126 supports the contact support portion 124. In one or more embodiments, the base portion 126 is configured to properly support the contact support portion 124 so that no gap is formed therebetween. In one or more embodiments, the base portion 126 is formed from a second material, such as aluminum (Al) or an aluminum alloy (e.g., an aluminum-magnesium-silicon (AlMgSi) alloy, such as AA6061). Advantageously, aluminum and its alloys can be selected to have good machinability and high strength while being lightweight. In addition, aluminum and its alloys have high thermal conductivity, which allows cooling to rapidly take place even with the chamfering tool 104 is at a high temperature.

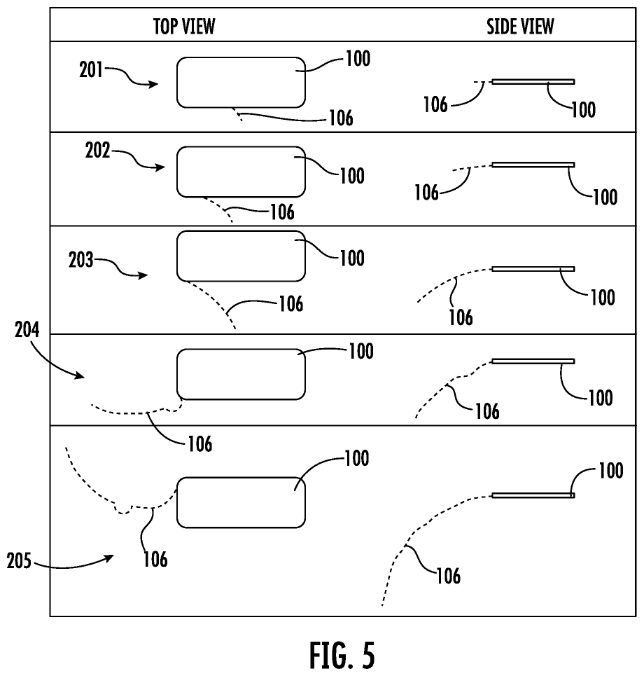

Having described the general arrangement and process of heat chamfering, the following discussion and FIGS. 5-14 relate to a support for the continuous strip of glass formed during heat chamfering and to a glass substrate formed thereby. FIG. 5 depicts stages of development of the continuous strip 106. In a first stage 201 of the depicted embodiment, the heat chamfering process begins along a linear side, as opposed to a curved side or corner, of the edge 102 of the glass substrate, and the glass strip 106 begins to peel from the glass substrate 100. A linear side of the edge 102 provides a stable starting and stopping point for the heat chamfering process. In a second stage 202, the glass strip 106 continues to grow as the heat chamfering process moves toward the first corner of the glass substrate 100, and in a third stage 203, the heat chamfering process reaches the first corner of the glass substrate 100. In a fourth stage 204, the heat chamfering process has advanced around the first corner of the glass substrate 100, producing a curved section of the glass strip 106. In a fifth stage 205, the heat chamfering process reaches the next corner, and the glass strip 106 remains continuous. In one or more embodiments, the heat chamfering process will continue until the entire edge 102 of the glass substrate 100 is removed, leaving the chamfered edge 110.

The strip 106 is continuous and grows throughout the heat chamfering process, and the vibration of the continuous strip 106 during heat chamfering can affect the ultimate properties of the chamfered edge 110. In particular, Applicant believes without wishing to bound by theory that vibration or excessive vibration of the strip 106 creates Hackle marks on the chamfered edge 110. Additionally, as the strip 106 grows, the mass of the strip 106 increases, changing the tension between the strip 106 and the glass substrate 100. Further, the angle at which the strip 106 separates from the glass substrate 100 can change if the strip 106 is not adequately supported, which can affect the uniformity of the strip thickness and therefore edge quality. In one or more embodiments, the angle between the strip 106 and the chamfered edge 110 as viewed from the first major surface 108 or the second major surface 120 (i.e., top view of FIG. 5) is maintained in a range of from about 5° to about 60°. In one or more embodiments, the angle between the strip 106 and the chamfered edge 110 as viewed from the perpendicular to the first major surface 108 or the second major surface 120 (i.e., side view of FIG. 5) is maintained in a range of from about 100° to about 180° as measured up to 10 mm away from chamfered edge 100.

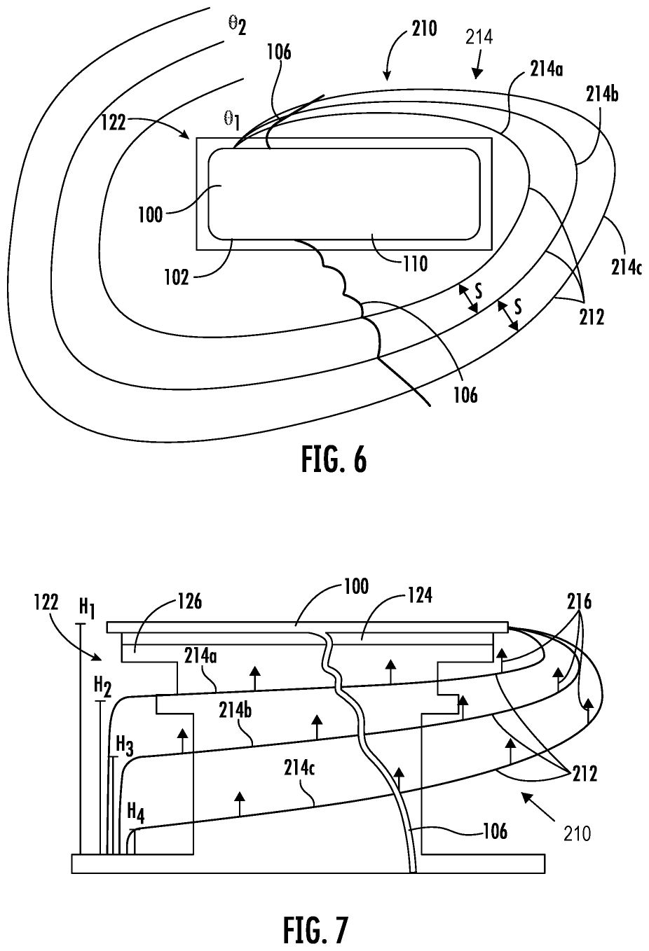

Thus, according to the present disclosure, embodiments of a support for the continuous strip are provided. FIGS. 6 and 7 depict a first embodiment of a support 210. As can be seen, the support 210 is positioned adjacent to the jig 122. In one or more embodiments, the support 210 includes one or more platform structures 212 configured to reduce vibration of the continuous strip 106 as the continuous strip 106 grows during heat chamfering of the glass substrate 100. Further, in one or more embodiments, the one or more platform structures 212 are further configured to maintain an angle that the continuous strip forms with the glass substrate 100 during heat chamfering.

In one or more embodiments, including the embodiment shown in FIGS. 6 and 7, the one or more platform structures 212 define at least one rail 214 that spirals around the jig 122. In the embodiment shown in FIGS. 6 and 7, the at least one rail 214 is three rails, shown as first rail 214a, second rail 214b, and third rail 214c.

Referring to the first rail 214a, the first rail 214a spirals from a first height H₁ at a first radial position θ₁ to a second height H₂ at a second radial position θ₂. The second height H₂ is lower than the first height H₁. In one or more embodiments, the second radial position θ₂ is at least three quarters of the way around the jig 122 from the first radial position θ₁. In one or more preferred embodiments, the second radial position θ₂ is all the way around the jig 122 from the first radial position θ₁ (i.e., the second radial position θ₂ is equal to the first radial position θ₁, albeit at a different height).

Similarly, the second rail 214b spirals from the first height H₁ at the first radial position θ₁ to a third height H₃ at the second radial position θ₂. In one or more embodiments, the third height H₃ is lower than both the first height H₁ and the second height H₂.

In embodiments including the third rail 214c, the third rail 214c spirals from the first height H₁ at the first radial position θ₁ to a fourth height H₄ at the second radial position θ₂. In one or more embodiments, the fourth height H₄ is lower than each of the first height H₁, the second height H₂, and the third height H₃.

In this way, the rails 214 taper in height as the continuous strip 106 grows during the heat chamfering process to match and support the angle at which the strip 106 separates from the glass substrate 100 (e.g., as shown in FIG. 5, stages 201-205). Further, in one or more embodiments, the spacing S between rails 214 increases as the rails 214 spiral around the jig 122, which also helps to support the growing continuous strip 106 during heat chamfering.

In one or more embodiments, the heights H₂, H₃, H₄ and spacings S of the rails are selected to maintain the desired angle (e.g., about 100° to about) 180° of the strip 106 as it bangs from the glass substrate 100 and grows in length as the chamfering process proceeds. In one or more embodiments, the heights of the rails and spacings between the rails satisfy the relationship of 0.01≤(Hₙ−Hₙ₊₁)/S≤5.67, in which Ha is the height of a first rail, Hₙ₊₁ is the height of the adjacent rail, and S is the spacing between the two rails. In one or more embodiments, this relationship is maintained throughout the spiral of the rails 214, taking into consideration the length of the strip 106 that will be produced based on the length of the edge 102 (i.e., perimeter) of the glass substrate 100.

In one or more embodiments, the rails 214 each have a length. In one or more embodiments, a plurality of ports 216 is formed in each of the rails 214 over their respective lengths. Air or another fluid is configured to be forced through the plurality of ports 216 of each rail 214 to reduce friction between the continuous strip 106 and each rail 214. In one or more embodiments, each port 216 has a diameter in a range from 0.1 mm to 1 mm, and in one or more embodiments, each rail 214 includes from 1 port per inch to 150 ports per inch.

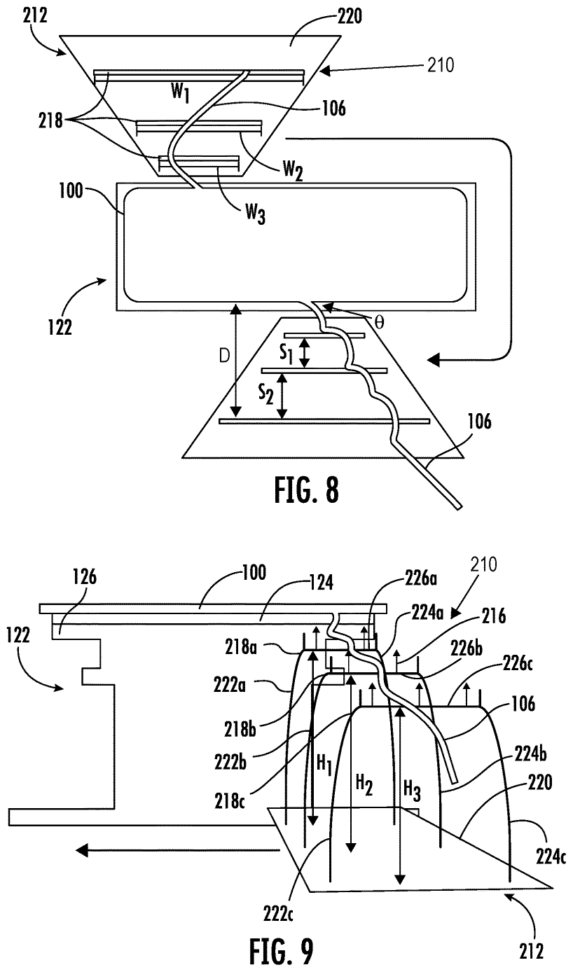

FIGS. 8 and 9 depict another embodiment of the support 210. In one or more such embodiments, the one or more platform structures 212 are configured to move radially around the jig 122. In one or more embodiments, the one or more platform structures 212 include at least one arch 218 disposed on a first movable base 220. In the embodiment depicted, the at least one arch 218 includes first arch 218a, second arch 218b, and third arch 218c.

Referring first to the first arch 218a, the first arch 218a includes a first leg 222a extending from the first movable base 220, a second leg 224a extending from the first movable base 220, and a cross-piece 226a disposed between the first leg 222a and the second leg 224a. The cross-piece 226a of the first arch 218a is a first height H₁ above the first movable base 220. The second arch 218b includes a first leg 222b extending from the movable base 220, a second leg 224b extending from the first movable base 220, and a cross-piece 226b disposed between the first leg 222b and the second leg 224b. The cross-piece 226b of the second arch 218b is a second height H₂ above the first movable base 220. In one or more embodiments, the second height H₂ is lower than the first height H₁. In embodiments in which the third arch 218c is included, the third arch 218c includes a first leg 222c extending from the first movable base 220, a second leg 224c extending from the first movable base 220, and a cross-piece 226c disposed between the first leg 222c and the second leg 224c. The cross-piece 226c of the third arch 218c is a third height H₄ above the first movable base 220. In one or more embodiments, the third height H₃ is lower than both the first height H₁ and the second height H₂. In this way, the height of the arches 218 tapers to mimic the drape of the continuous strip 106 as it separates from the glass substrate 100.

Further, in one or more embodiments, each cross-piece 226a, 226b, 226c has a respective width W₁, W₂, W₃. In one or more embodiments, the width of each cross-piece increases as the distance from the jig 122 increases. Thus, for example, the first width W₁ of cross-piece 226a is less than the second width W₂ of the cross-piece 226b, and the second width W₂ of the cross-piece 226b is less than the third width W₃ of the cross-piece 226c.

In one or more embodiments, the first arch 218a is spaced from the second arch 218b by a first spacing S₁, and the second arch 218b is spaced from the third arch 218c by a second spacing S₂. In one or more embodiments, the first spacing S₁ is less than the second spacing S₂.

In one or more embodiments, the heights of the arches 218 and spacings between the arches 218 satisfy the relationship of 0.01≤(Hₙ−Hₙ+1)/S≤5.67, in which Hₙ is the height of a first arch, Hₙ₊₁ is the height of the next adjacent arch, and S is the spacing between the two arches. Further, in one or more embodiments, the widths of the arches 218 are selected such that the widths satisfy the relationship of W≥2*D*tan(θ), in which W is the width of the arch 218, D is the distance that the arch 218 is from the glass substrate 100, and θ is the angle between the glass strip 106 the glass substrate 100 when viewed from above.

In one or more embodiments, a plurality of ports 216 is formed over the width W₁, W₂, W₃ of each cross-piece 226a, 226b, 226c. Air or another fluid is configured to be forced through the plurality of ports 216 of the cross-pieces 226a, 226b, 226c to reduce friction between the continuous strip 106 and the cross-pieces 226a, 226b, 226c.

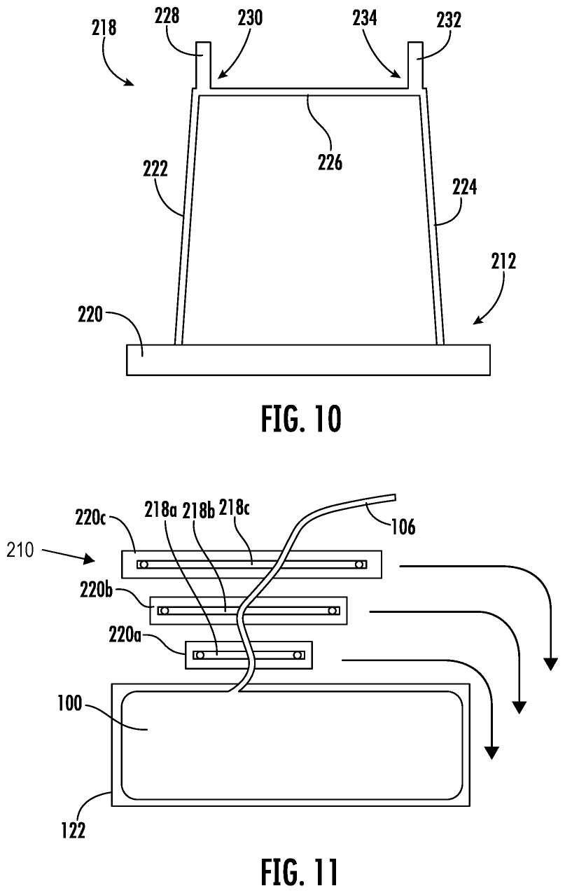

FIG. 10 depicts an embodiment of a single arch 218, which can be representative of any of the first arch 218a, the second arch 218b, or third arch 218c. In one or more embodiments, the arch 218 includes a first end block 228 extending from a first end 230 of the cross-piece 226 and a second end block 232 extending from a second end 234 of the cross-piece 226. The first end block 228 and the second end block 232 provide boundaries to contain the continuous strip 106 during heat chamfering.

In particular, the first movable base 220 moves around the jig 122 during the heat chamfering process in such a manner that the one or more arches 218 support the continuous strip 106 as it grows. In one or more embodiments, the jig 122 is stationary, and the chamfering tool 104 is moved around the glass substrate 100. In such embodiments, the first movable base 220 is moved with the chamfering tool 104 at the same rate as the chamfering tool 104. In this way, the arches 218 support the continuous strip as it grows, and when included, the end blocks 228, 232 ensure that the continuous glass strip 106 remains over the arches 218 during heat chamfering.

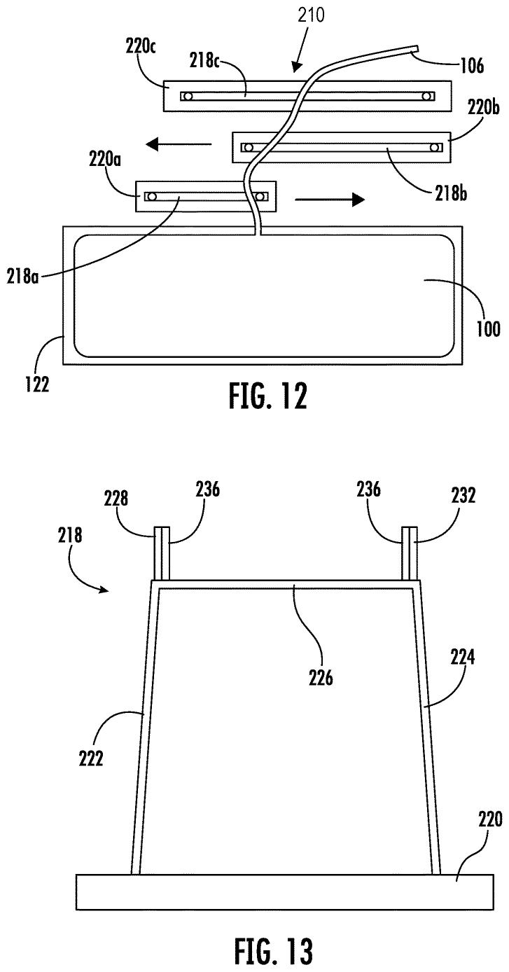

FIGS. 11 and 12 depict another embodiment of the support 210 in which multiple arches 218 are provided on multiple moving bases 220. In one or more embodiments, the bases 220 move autonomously using navigational sensors and/or using track systems. In one or more embodiments, a first arch 218a is provided on a first movable base 220a, a second arch 218b is provided on a second movable base 220b, and a third arch 218c is provided on a third movable base 220c. By providing the arches 218a, 218b, 218c on separate movable bases 220a, 220b, 220c, the bases 220a, 220b, 220c can moved independently of one another. Thus, as shown for example in FIG. 12, the movable bases 220a, 220b, 220c may not be in alignment at all times during the course of the heat chamfering process. Specifically, the movable bases 220a, 220b, 220b may move at different rates to provide adequate support for the continuous strip 106.

FIG. 13 depicts an embodiment of an arch 218 for use on any one of the independently movable bases 220. In one or more embodiments, the arch 218 includes a first end block 228 and a second end block 232 as described above. In one or more embodiments, the end blocks 228, 232 each include sensors 236 configured to detect contact with or proximity of the continuous strip 106 (e.g., a distance monitoring sensor unit or a collision avoidance sensor unit). In such embodiments, the sensor 236 on the leading end block 232 may cause the movable base 220 to increase its rate of movement if the continuous strip 106 is close to the leading end block 232. In contrast, the sensor 236 on the trailing end block 228 may cause the movable base 220 to decrease its rate of movement if the continuous strip 106 is close to the trailing end block 228. In this way, the changing shape of the continuous strip 106 as it grows during heat chamfering can be accounted for and supported by the arches 218.

According to the present disclosure, the support for the continuous strip enhances the quality of the chamfered edge of the glass substrate. In particular, the glass substrate has low waviness of the chamfered edge. To determine characteristics of the chamfered edge, two glass samples were heat chamfered. One glass sample was prepared without using a support 210 according to the present disclosure to stabilize the strip 106, and one glass sample was prepared using a support 210 according to the present disclosure to stabilize the strip 106 during chamfering. Each glass sample was a rectangular glass sample, and eight positions around each chamfered edge were sampled, including one sample at the midpoint of each short edge and three equidistantly-spaced samples on each of the long edges.

At each of the eight positions of each sample, average roughness (Rₐ) and maximum peak-to-trough roughness (R_{z}) were measured along a 3000 μm sampling length. The roughness measurements are provided in Table 1, below.

TABLE 1
Surface Roughness of Supported and
Unsupported Chamfered Glass Samples

| Unsupported | 1 | 2 | 3 | 4 | 5 | 6 | 7 | 8 |
|---|---|---|---|---|---|---|---|---|
| Rₐ (μm) | 0.2 | 0.2 | 0.2 | 2.5 | 0.6 | 0.2 | 0.2 | 0.2 |
| R_{z} (μm) | 0.9 | 1.2 | 1.2 | 16 | 2.7 | 1.2 | 1.3 | 1.7 |

| Supported | 1 | 3 | 3 | 4 | 5 | 6 | 7 | 8 |
|---|---|---|---|---|---|---|---|---|
| Rₐ (μm) | 0.1 | 0.2 | 0.2 | 0.1 | 0.7 | 1.5 | 0.1 | 0.2 |
| R_{z} (μm) | 0.7 | 1.2 | 1.2 | 0.6 | 2.9 | 6.0 | 0.6 | 0.8 |

As can be seen from Table 1, the glass sample chamfered using the support 210 had an overall lower roughness. In particular, the maximum average roughness (Rₐ) measured around the unsupported sample was 2.5 μm, whereas the maximum average roughness (Rₐ) measured around the supported sample was 1.5 μm. Further, the maximum peak-to-trough roughness (R_{z}) measured around the unsupported sample was 16 μm, whereas the maximum peak-to-trough roughness (R_{z}) measured around the supported sample was 6 μm. The average of the roughness values for the unsupported sample was 0.5 μm (Rₐ) and 3.3 μm (R_{z}) with a standard deviation of 0.8 μm and 5.2 μm, respectively. The average of the roughness values for the supported sample was 0.4 μm (Rₐ) and 1.8 μm (R_{z}) with a standard deviation of 0.5 μm and 1.9 μm, respectively. Thus, the average roughness around the chamfered edge was lower for the supported sample with a lower level of variance.

In one or more embodiments, the average surface roughness (Rₐ) of the chamfered edge 110 around the glass substrate 100 is less than 0.5 μm, and the maximum surface roughness (Rₐ) of the chamfered edge 110 around the glass substrate 100 is 2.0 μm or less. In one or more embodiments, the average surface roughness (R_{z}) of the chamfered edge 110 around the glass substrate 100 is 2.0 μm or less, and the maximum surface roughness (R_{z}) of the chamfered edge 110 around the glass substrate 100 is 10.0 μm or less.

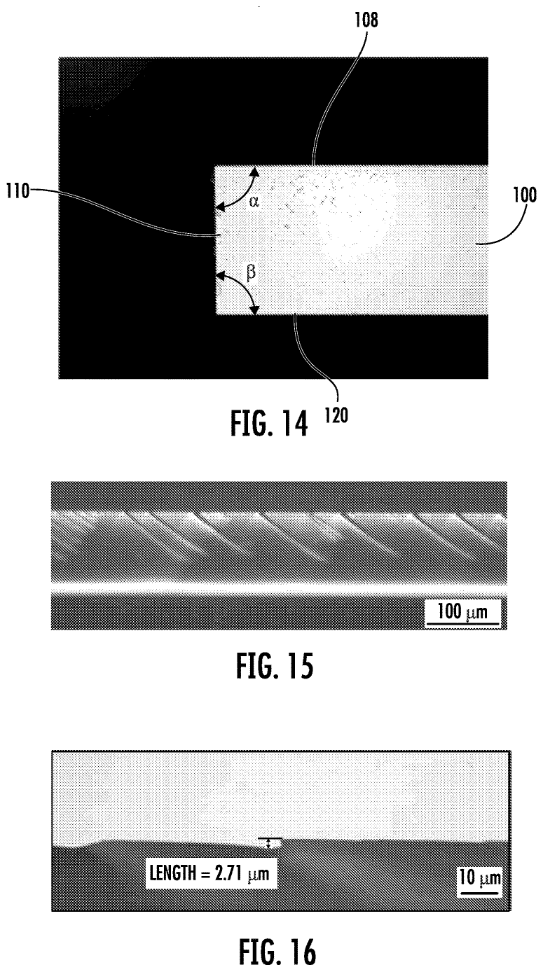

FIG. 14 depicts a chamfered edge 110 of a glass substrate 100. As shown in FIG. 14, the chamfered edge 110 forms a first angle α with the first major surface 108 and a second angle β with respect to the second major surface 120. In one or more embodiments, the first angle α and the second angle β of the chamfered edge 110 around the glass substrate 100 are both within 15°, in particular within 10° and most particularly within 5°, of perpendicular with respect to the first major surface 108 and the second major surface 120, respectively.

At each of the eight positions at which the roughness was measured, the perpendicularity of the chamfered edge was also measured for both a sample chamfered using a support for the glass strip and a sample chamfered without using a support for the glass strip. The measured first angle α and the measured second angle β for the eight positions around each sample are provided in Table 2, below.

TABLE 2
Perpendicularity of Chamfered Edge of Glass Samples

| | 1 | 2 | 3 | 4 | 5 | 6 | 7 | 8 |
|---|---|---|---|---|---|---|---|---|
| Unsupported | | | | | | | | |
| α | 89.73 | 89.51 | 91.97 | 108.77 | 102 | 91.69 | 86.99 | 92.51 |
| β | 90.27 | 90.56 | 88.15 | 71.56 | 78.25 | 88.36 | 93.4 | 87.45 |
| Supported | | | | | | | | |
| α | 90.23 | 87.74 | 86.78 | 88.62 | 78.01 | 75.81 | 90.37 | 89.32 |
| β | 89.5 | 89.05 | 93.38 | 91.48 | 102.3 | 104.7 | 89.94 | 90.55 |

From Table 2, the average first angle α for the unsupported glass sample was 94.1°, and the average second angle β for the unsupported glass sample was 86.0°. The average first angle α for the supported glass sample was 85.9°, and the average second angle β for the supported glass sample was 93.9°. While the average first and second angles α, β of the unsupported and supported glass samples were relatively close, the difference between the minimum and maximum of the first and second angles α, β was greater for the unsupported glass sample than for the supported glass sample. For the unsupported sample, the difference between the minimum and maximum of the first angle α was 21.78°, and the difference between the minimum and maximum of the second angle β was 21.84°. For the supported sample, the difference between the minimum and maximum of the first angle α was 14.56°, and the difference between the minimum and maximum of the second angle β was 15.68°. Further, for the unsupported glass sample, the standard deviation of the measured first and second angles α, β was 7.373° and 7.316°, respectively, and for the supported glass sample, the standard deviation of the measured first and second angles α, β was 5.682° and 6.144°, respectively. In this way, the support for the glass strip 106 reduces the variance in the first and second angle α, β of the chamfered edge 110.

In one or more embodiments, the difference between the minimum and the maximum first angle α and second angle β measurements is 20.0° or less, in particular 17.0° or less, around the chamfered edge 110. Further, in one or more embodiments, the standard deviation of the first angle α and of the second angle β as measured around the chamfered edge 110 of the glass substrate 100 is 7.0° or less.

Advantageously, the embodiments of the support 210 described herein reduce the formation of various defects and unevenness on the chamfered edge 110. FIG. 15 depicts an example of Hackle marks that can be formed on a chamfered edge of a glass substrate that is chamfered without using a support 210 for the glass strip 106. FIG. 16 provides a side view of the chamfered edge depicting the unevenness of the edge as a result of not supporting the glass strip generated during chamfering. By using a support 210, the formation of Hackle marks and unevenness as shown in FIGS. 15 and 16 is substantially reduced or eliminated. Also advantageously, the reduction of such defects not only enhances the cosmetic appearance of the chamfered edge but may also improve the edge strength, and thus the reliability and longevity, of the glass substrate.
Aspect (1) of this disclosure pertains to a support for a continuous strip formed during chamfering of a glass substrate that is situated on a jig, the support comprising: one or more platform structures positioned adjacent to the jig and configured to reduce vibration of the continuous strip as the continuous strip grows during the chamfering of the glass substrate.
Aspect (2) of this disclosure pertains to the support of Aspect (1), wherein the one or more platform structures comprises a first rail that spirals around the jig from a first height at a first radial position to a second height at a second radial position, the second height being lower than the first height.
Aspect (3) of this disclosure pertains to the support of Aspect (2), wherein the second radial position is at three quarters around the jig from the first radial position.
Aspect (4) of this disclosure pertains to the support of Aspect (2) or Aspect (3), wherein the one or more platform structures further comprises a second rail that spirals around the jig from a first height at the first radial position to a third height at a third radial position, the third height being lower than the second height.
Aspect (5) of this disclosure pertains to the support of any one of Aspects (2) through (4), wherein the first rail comprises a length, wherein a plurality of ports is formed in the first rail over the length, and wherein air is configured to be forced through the plurality of ports of the first rail to reduce friction between the continuous strip and the first rail.
Aspect (6) of this disclosure pertains to the support of Aspect (1), wherein the one or more platform structures are configured to move around the jig.
Aspect (7) of this disclosure pertains to the support of Aspect (6), wherein the one or more platform structures comprises a first arch disposed on a first movable base, the first arch having a first leg extending from the first movable base, a second leg extending from the first movable base, and a first cross-piece disposed between the first leg and the second leg.
Aspect (8) of this disclosure pertains to the support of Aspect (7), wherein a plurality of ports is formed in the first cross-piece and wherein air is configured to be forced through the plurality of ports of the first cross-piece to reduce friction between the continuous strip and the first cross-piece.
Aspect (9) of this disclosure pertains to the support of Aspect (7) or Aspect (8), wherein the first arch further comprises a first end block extending from a first end of the first cross-piece and a second end block extending from a second end of the first cross-piece and wherein the first end block and the second end block guide the continuous strip as the first movable base moves radially around the jig.
Aspect (10) of this disclosure pertains to the support of Aspect (9), wherein the first end block and the second end block comprise sensors configured to detect contact or proximity of the continuous strip with the first end block or the second end block.
Aspect (11) of this disclosure pertains to the support of any one of Aspects (7) through (10), wherein the one or more platform structures further comprises a second arch disposed on the first movable base, the second arch comprising a third leg extending from the first movable base, a fourth leg extending from the first movable base, and a second cross-piece disposed between third leg and the fourth leg.
Aspect (12) of this disclosure pertains to the support of any one of Aspects (7) through (10), wherein the one or more platform structures further comprises a second arch disposed on a second movable base, the second arch comprising a third leg extending from the first movable base, a fourth leg extending from the first movable base, and a second cross-piece disposed between third leg and the fourth leg, and wherein the second movable base is configured to move independently of the first movable base.
Aspect (13) of this disclosure pertains to the support of Aspect (11) or Aspect (12), wherein the first cross-piece is disposed between the first leg and the second leg at a first height and the second cross-piece is disposed between the third leg and the fourth leg at a second height, the second height being lower than the first height.
Aspect (14) of this disclosure pertains to a heat chamfering system, comprising: a jig configured to hold a glass substrate; a tool configured to move relative to the jig to remove a continuous strip from the glass substrate; the support according to any one of Aspects (1) through (13) positioned adjacent to the jig.
Aspect (15) of this disclosure pertains to the heat chamfering system of Aspect (14), wherein the tool comprises an induction heated tip.
Aspect (16) of this disclosure pertains to the heat chamfering system of Aspect (14) or Aspect (15), wherein the support is stationary relative to the jig.
Aspect (17) of this disclosure pertains to the heat chamfering system of Aspect (14) or Aspect (15), wherein the support is configured to move at least partially around the jig.
Aspect (18) of this disclosure pertains to a method of chamfering an edge of a glass substrate, comprising: moving a tool around the edge of the glass substrate to remove glass material in a continuous strip; supporting the continuous strip on a platform structure to reduce vibration of the continuous strip during removal of the glass material from the glass substrate.
Aspect (19) of this disclosure pertains to the method of Aspect (18), wherein the platform structure comprises a first rail that spirals around the jig from a first height at a first radial position to a second height at a second radial position, the second height being lower than the first height.
Aspect (20) of this disclosure pertains to the method of Aspect (19), wherein the second radial position is at least three quarters around the jig from the first radial position.
Aspect (21) of this disclosure pertains to the method of Aspect (18) or Aspect (19), wherein the platform structure further comprises a second rail that spirals around the jig from a first height at the first radial position to a third height at a third radial position, the third height being lower than the second height.
Aspect (22) of this disclosure pertains to the method of any one of Aspects (19) through (21), wherein the first rail comprises a length, wherein a plurality of ports is formed in the first rail over the length, and wherein the method further comprises forcing air through the plurality of ports of the first rail to reduce friction between the continuous strip and the first rail.
Aspect (23) of this disclosure pertains to the method of Aspect (19), wherein supporting further comprises moving the platform around the jig.
Aspect (24) of this disclosure pertains to the method of Aspect (23), wherein the platform structure comprises a first arch disposed on a first movable base, the first arch having a first leg extending from the base, a second leg extending from the first movable base, and a first cross-piece disposed between the first leg and the second leg.
Aspect (25) of this disclosure pertains to the method of Aspect (24), wherein a plurality of ports is formed in the first cross-piece and wherein the method further comprises forcing air through the plurality of ports of the first cross-piece to reduce friction between the continuous strip and the first cross-piece.
Aspect (26) of this disclosure pertains to the method of Aspect (24) or Aspect (25), wherein the first arch further comprises a first end block extending from a first end of the first cross-piece and a second end block extending from a second end of the first cross-piece and wherein the method further comprises guiding the continuous strip with the first end block and the second end block as the first movable base moves radially around the jig.
Aspect (27) of this disclosure pertains to the method of Aspect (26), wherein the first end block and the second end block comprise sensors configured to detect contact or proximity of the continuous strip with the first end block or the second end block and wherein the method further comprises adjusting a rate at which the platform structure is moved around the jig based on feedback from the sensors.
Aspect (28) of this disclosure pertains to the method of any one of Aspects (24) through (27), wherein the one or more platform structures further comprises a second arch disposed on the first movable base, the second arch comprising a third leg extending from the first movable base, a fourth leg extending from the first movable base, and a second cross-piece disposed between third leg and the fourth leg.
Aspect (29) of this disclosure pertains to the method of any one of Aspects (24) through (27), wherein the one or more platform structures further comprises a second arch disposed on a second movable base, the second arch comprising a third leg extending from the first movable base, a fourth leg extending from the first movable base, and a second cross-piece disposed between third leg and the fourth leg, and wherein the method further comprises moving the second movable base independently of the first movable base.
Aspect (30) of this disclosure pertains to the method of Aspect (28) or (29), wherein the first cross-piece is disposed between the first leg and the second leg at a first height and the second cross-piece is disposed between the third leg and the fourth leg at a second height, the second height being lower than the first height.
Aspect (31) of this disclosure pertains to a glass substrate, comprising: a glass body comprising a first major surface, a second major surface opposite to the first major surface, and a heat chamfered edge extending at least partially around the glass body between the first major surface and the second major surface; wherein a maximum peak-to-trough surface roughness R_{z} of the heat chamfered edge is 10.0 μm or less.
Aspect (32) of this disclosure pertains to the glass substrate of Aspect (31), wherein the heat chamfered edge is free of Hackle marks.
Aspect (33) of this disclosure pertains to the glass substrate of Aspect (31) or Aspect (32), wherein the glass body comprises a glass material selected from a group consisting of borosilicate glass, aluminosilicate glass, boroaluminosilicate glass, and combinations thereof.
Aspect (34) of this disclosure pertains to the glass substrate of any one of Aspects (31) through (33), wherein an average of a plurality of average surface roughness Rₐ measurements around the heat chamfered edge is less than 0.5 μm.
Aspect (35) of this disclosure pertains to the glass substrate of Aspect (34), wherein each average surface roughness Rₐ measurement of the plurality of average surface roughness Rₐ measurements is 2.0 μm or less.
Aspect (36) of this disclosure pertains to the glass substrate of any one of Aspect (31) through (35), wherein an average of a plurality of peak-to-trough surface roughness R_{z} measurements around the heat chamfered edge is 2.0 μm or less.
Aspect (37) of this disclosure pertains to the glass substrate of any one of Aspect (31) through (36), wherein the heat chamfered edge forms a first angle with the first major surface and a second angle with the second major surface and wherein each of the first angle and the second angle are within 15° of perpendicular.
Aspect (38) of this disclosure pertains to the glass substrate of Aspect (37), wherein, for a plurality of first angles measured around the heat chamfered edge, a difference between a maximum measured first angle and a minimum measured first angle is 20.0° or less.
Aspect (39) of this disclosure pertains to the glass substrate of Aspect (38), wherein a standard deviation of the plurality of first angles measured around the heat chamfered edge is 7.0° or less.
Aspect (40) of this disclosure pertains to the glass substrate of any one of Aspect (37) through (39), wherein, for a plurality of second angles measured around the heat chamfered edge, a difference between a maximum measured second angle and a minimum measured second angle is 20.0° or less.
Aspect (40) of this disclosure pertains to the glass substrate of Aspect (40), wherein a standard deviation of the plurality of second angles measured around the heat chamfered edge is 7.0° or less.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A method of chamfering an edge of a glass substrate, comprising:
moving a tool around the edge of the glass substrate to remove glass material in a continuous strip;
supporting the continuous strip on a platform structure to reduce vibration of the continuous strip during removal of the glass material from the glass substrate.

2. The method of claim 1, wherein the platform structure comprises a first rail that spirals around the jig from a first height at a first radial position to a second height at a second radial position, the second height being lower than the first height.

3. The method of claim 2, wherein the second radial position is at least three quarters around the jig from the first radial position.

4. The method of claim 1, wherein the platform structure further comprises a second rail that spirals around the jig from a first height at the first radial position to a third height at a third radial position, the third height being lower than the second height.

5. The method of claim 2, wherein the first rail comprises a length, wherein a plurality of ports is formed in the first rail over the length, and wherein the method further comprises forcing air through the plurality of ports of the first rail to reduce friction between the continuous strip and the first rail.

6. The method of claim 2, wherein supporting further comprises moving the platform around the jig.

7. The method of claim 3, wherein the platform structure comprises a first arch disposed on a first movable base, the first arch having a first leg extending from the base, a second leg extending from the first movable base, and a first cross-piece disposed between the first leg and the second leg.

8. The method of claim 7, wherein the one or more platform structures further comprises a second arch disposed on the first movable base, the second arch comprising a third leg extending from the first movable base, a fourth leg extending from the first movable base, and a second cross-piece disposed between third leg and the fourth leg.

9. The method of claim 7, wherein the one or more platform structures further comprises a second arch disposed on a second movable base, the second arch comprising a third leg extending from the first movable base, a fourth leg extending from the first movable base, and a second cross-piece disposed between third leg and the fourth leg, and wherein the method further comprises moving the second movable base independently of the first movable base.

10. The method of claim 8 or claim 9, wherein the first cross-piece is disposed between the first leg and the second leg at a first height and the second cross-piece is disposed between the third leg and the fourth leg at a second height, the second height being lower than the first height.

11. A glass substrate, comprising
a glass body comprising a first major surface, a second major surface opposite to the first major surface, and a heat chamfered edge extending at least partially around the glass body between the first major surface and the second major surface;
wherein a maximum peak-to-trough surface roughness R_{z} of the heat chamfered edge is 10.0 μm or less.

12. The glass substrate of claim 11, wherein the heat chamfered edge is free of Hackle marks.

13. The glass substrate of claim 11, wherein the glass body comprises a glass material selected from a group consisting of borosilicate glass, aluminosilicate glass, boroaluminosilicate glass, and combinations thereof.

14. The glass substrate of claim 11, wherein an average of a plurality of average surface roughness Rₐ measurements around the heat chamfered edge is less than 0.5 μm.

15. The glass substrate of claim 14, wherein each average surface roughness Rₐ measurement of the plurality of average surface roughness Rₐ measurements is 2.0 μm or less.

16. The glass substrate of claim 11, wherein an average of a plurality of peak-to-trough surface roughness R_{z} measurements around the heat chamfered edge is 2.0 μm or less.

17. The glass substrate of claim 11, wherein the heat chamfered edge forms a first angle with the first major surface and a second angle with the second major surface and wherein each of the first angle and the second angle are within 15° of perpendicular.

18. The glass substrate of claim 17, wherein, for a plurality of first angles measured around the heat chamfered edge, a difference between a maximum measured first angle and a minimum measured first angle is 20.0° or less.

19. The glass substrate of claim 18, wherein a standard deviation of the plurality of first angles measured around the heat chamfered edge is 7.0° or less.

20. The glass substrate of claim 17, wherein, for a plurality of second angles measured around the heat chamfered edge, a difference between a maximum measured second angle and a minimum measured second angle is 20.0° or less.
